(19) United States
(12) Patent Application Publication
(10) Pub. No.: US 2019/0085921 A1
(43) Pub. Date: Mar. 21, 2019

(54) RETRACTION SPRING ASSEMBLY FOR BRAKE SYSTEM

(71) Applicant: AKEBONO BRAKE INDUSTRY CO., LTD, Tokyo (JP)

(72) Inventors: James Andrew Reuss, Farmington Hills, MI (US); Brad Robert Lethorn, Northville, MI (US)

(21) Appl. No.: 15/711,493

(22) Filed: Sep. 21, 2017

(51) Int. Cl. F16D 65/097

(52) U.S. Cl. CPC F16D 65/097; F16D 2055/0029

(57) ABSTRACT

A retraction spring having: a) a bias device which stores energy during a brake apply and releases the energy during a brake release b) an anchor arm integrally attached at the support side arm of the bias device; c) a retraction arm integrally attached at the pad side arm of the bias device; wherein the loop axis lies within and is generally parallel to a transverse plane; wherein during the brake apply, movement of the retraction arm is away from the bias device, away from the anchor arm, and/or toward a rotor and results in the energy being stored in the bias device; and wherein during the brake release, the energy stored in the bias device is released and transferred to the retraction arm to result in movement of the retraction arm toward the bias device, toward the anchor arm, and/or away from the rotor.

### FIELD

The present teachings generally relate to a brake system, and more particularly to a retraction spring assembly which assists in retracting brake pads. The retraction spring assembly may be particularly advantageous in being mountable to many varying brake systems without design modifications.

### BACKGROUND

Typical disc brake systems include a support bracket, two or more brake pads, a caliper, and a rotor. The two or more brake pads are mounted and located adjacent to the support bracket so that the brake pads move axially toward and away from the rotor. The disc brake system may include a pad clip that attaches to the support bracket and to a portion of one or more of the brake pads so that the brake pads are held in the support bracket. The disc brake system may include one or more springs that attach to the brake pads and pad clips to assist in retracting the brake pads. The spring and pad clip form a retraction spring assembly. The addition of one or more pad clips and/or one or more springs may require modifications to be made to the support bracket, brake pads, caliper body, or combination thereof so that the spring and/or pad clip may be used. In addition, these springs may not be used with existing braking systems because the spring does not fit without the modifications discussed above. Examples of springs, clips, and other retraction devices are disclosed in U.S. Pat. Nos. 4,364,455; 4,491,204; 5,249,647; 5,511,638; 5,537,103; 6,378,665; 6,920,965; 7,308,974; 7,467,693; 8,393,441; and 9,261,152; U.S. Patent Application Nos. 2002/0189911; PCT Publication No. WO 2011/126125; and Japanese Patent No. 56-21633U, all of which are expressly incorporated herein by reference for all purposes.

One challenge faced by typical pad clips is the pad clip may need to specifically be designed to provide clearance for a rotor. The pad clip is mated with ends of opposing brake pads, thus needing to extend over a rotor gap. To provide the gap, a bridge distances and connects legs of the pad clip. As the bridge forms a predetermined distance between the legs, the pad clip has a fixed width and is limited to specific calipers having the same distance between opposing components of the brake caliper.

Existing spring assemblies may not work with “new” or “modified” brake systems and may need to be re-designed to specifically cooperate with each brake system and/or the clip that the spring is incorporated into. These springs may require special pad clips, brake pads, pressure plates, support brackets, caliper housings, additional clearances between components, or other additional features so that the retraction spring assembly is held in place.

Some springs and/or clips are “over the rotor” designs (i.e., the spring and/or clip is directly over the rotor) and may be subject to interference with moving parts such as the rotor or the wheel. For example, the retraction spring assembly may contact the rotor, the caliper housing, or both and move out of contact with the brake pads, become damaged, or become tangled within other parts causing damage to the other parts such as the rotor, brake pads, fluid lines, wheels, or a combination thereof. The over the rotor designs may require additional clips and/or support structures so that the spring does not contact other parts of the braking system, thus, adding expense to the brake system and preventing the retraction spring assembly from being added to existing systems easily. Some over the rotor designs may require the caliper housing to be redesigned so that there is enough space for the retraction spring assembly to fit under the caliper housing.

It is desirable for some brake systems to have tight brake pedal feel, for which minimal off-brake running clearance between the brake pads and rotor is required. Some disk brake systems may exhibit lateral run out (LRO) and disk thickness variation (DTV). Each rotor may exhibit some LRO as the rotor rotates, and each rotor may have some variation in disk thickness. As the rotor moves, the rotor may contact the brake pads at a high spot on the disk due to DVT, the rotor may contact the brake pads due to LRO, or both. Off-brake drag (a deceleration torque caused by contact between the pad and rotor when the brake system is not applied) due to decreased running clearance may cause increased brake pad wear, increased rotor wear, reduced vehicle fuel economy, or any combination thereof. Thus, there is a need for a device that can be incorporated into known braking systems, which minimizes and/or eliminates off-brake drag so that increased pad and rotor wear are reduced and/or eliminated and vehicle fuel economy improved.

Thus, there is a need for a retraction spring assembly that is light, strong, resistant to failure, and can be added into an existing braking system without any modifications to the braking system, retraction spring, and/or pad clip, or without using other additional parts, attachment points, and/or connections. There is a need for a pad clip which allows for flexibility for installation of a retraction spring assembly within varying caliper designs and sizes without being limited by the rotor gap. It would be attractive to have a retraction spring assembly that forms a removable connection with sufficient holding capabilities with one or more components of the brake system so that the retraction spring does not fall out during normal operation.

### SUMMARY

The present disclosure relates to a retraction spring comprising: a bias device which stores energy during a brake apply and releases the energy during a brake release, the bias device having: (i) one or more helical loops having a loop axis extending therethrough and concentric with a diameter of the one or more helical loops and a first end opposite a second end; (ii) a pad side arm located at the first end of the one or more helical loops; and (iii) a support side arm located at the second end of the one or more helical loops; (b) an anchor arm integrally attached at the support side arm of the bias device, the anchor arm connecting the retraction spring to a brake component; (c) a retraction arm integrally attached at the pad side arm of the bias device; wherein the loop axis lies within and is generally parallel to a transverse plane; wherein the pad side arm, the support side arm, the anchor arm, and the retraction arm are located on a same side of the transverse plane; wherein during the brake apply, movement of the retraction arm is away from the bias device, away from the anchor arm, and/or toward a rotor and results in the energy being stored in the bias device; and wherein during the brake release, the energy stored in the bias device is released and transferred to the retraction arm to result in movement of the retraction arm toward the bias device, toward the anchor arm, and/or away from the rotor.

The present disclosure relates to a retraction spring assembly comprising: a) a pad clip having a support channel adjacent to a pad channel; and b) a retraction spring affixed to the pad clip, the retraction spring comprising: (i) a bias device which stores energy during a brake apply and releases the energy during a brake release, the bias device having one or more helical loops with a loop axis extending therethrough and concentric with a diameter of the one or more helical loops, and the one or more helical loops are free of contact from the pad clip; (ii) an anchor arm integrally attached to the bias device, wherein the anchor arm affixes the retraction spring to the pad clip by residing within the support channel; (iii) a retraction arm integrally attached to the bias device; wherein the loop axis lies within and is generally parallel to a transverse plane; wherein the anchor arm and the retraction arm are located on a same side of the transverse plane; wherein during the brake apply, movement of the retraction arm is away from the bias device, away from the anchor arm, and/or toward a rotor and results in the energy being stored in the bias device; and wherein during the brake release, the energy stored in the bias device is released and transferred to the retraction arm to result in movement of the retraction arm toward the bias device, toward the anchor arm, and/or away from the rotor.

The present disclosure relates to a brake system comprising: a) a support bracket including a plurality of abutments; b) a pair of brake pads opposing one another and mounted to the support bracket, each brake pad including two or more ears; c) a rotor between the pair of brake pads; d) a plurality of retraction spring assemblies, each comprising: (i) a pad clip having: 1) a support channel which receives one of the plurality of abutments of the support bracket; and 2) a pad channel which receives one of the two or more ears from one of the pair of brake pads; (ii) a retraction spring affixed to the pad clip, the retraction spring having: 1) a bias device having one or more helical loops with a loop axis extending therethrough and concentric with a diameter of the one or more helical loops and the one or more helical loops are free of contact from the pad clip; 2) an anchor arm integrally attached to the bias device, wherein the anchor arm resides in the support channel adjacent to the abutment located within the support channel; 3) a retraction arm integrally attached to the bias device, wherein the retraction arm extends away from the bias device and is in direct contact with the ear located within the pad channel; wherein the loop axis lies within and is generally parallel to a transverse plane and the anchor arm and the retraction arm are located on a same side of the transverse plane; wherein during a brake apply, movement of the pair of brake pads toward the rotor results in each of the ears applying an inwardly force to the retraction arm which the ear is in contact with, and the retraction arm transfers the inwardly force to the bias device so that the inwardly force is stored as energy in the bias device; and wherein during a brake release, the energy stored in the bias device is released and transferred to the retraction arm so that the retraction arm applies an outwardly force to the ear it is in direct contact with to result in movement of the pair of brake pads away from the rotor.

The retraction spring assembly of the disclosure may be advantageous as it may be used with a significant variety of brake systems. An individual retraction spring may cooperate with an individual pad clip. The pad clip may be dedicated to an individual end of a brake pad without requiring a bridge portion. By eliminating a bridge portion, the pad clip may provide flexibility to allow the retraction spring assembly to be installed in brake systems having varying geometries, including varying rotor gap distances. The retraction spring may be incorporated around portions of and/or into portions of the pad clip so that vertical displacement (e.g., movement generally parallel to the face of the support bracket) of the retraction spring is minimized. The retraction spring may further extend through and/or around portions of the pad clip so that a portion of the retraction spring is in close proximity to and/or in contact with the support bracket so that movement is minimized and/or eliminated.

Another unique aspect of the present disclosure envisions a retraction spring assembly that can be incorporated into existing braking systems without the need for any modifications to the braking system, additional parts, adding expense, labor, or a combination thereof to the braking system. The present disclosure does not require any additional holes and/or coupling areas in which contact with the pressure plates of the brake pads is made so that the retraction spring may assist in retracting the brake pads, thus, the present disclosure may be used with a significant number of existing brake pad designs. Further, the present disclosure fits outside of the caliper housing and extends laterally away from the caliper housing and rotor so that the retraction spring may be used regardless of the caliper housing employed by the braking system.

The teachings herein may provide a device that can be incorporated into known braking systems, which minimizes and/or eliminates off-brake drag so that excessive pad and rotor wear are reduced and/or eliminated and vehicle fuel economy improved. The present teachings provide a retraction spring assembly that is light, strong, resistant to failure, and can be added into both new and existing braking systems without any modifications to the braking system, the retraction spring, and/or the pad clip or without using other additional parts. The present teachings provide a retraction spring assembly that can attach to existing brake components without modifications and/or addition of attachment points, connections, or both. Further, the present teachings provide a retraction spring assembly that forms a removable connection with sufficient holding capabilities with one or more components of the brake system so that the retraction spring does not fall out during normal operation.

### BRIEF DESCRIPTION OF THE DRAWINGS

FIG. 1 is a perspective view of a brake system.

FIG. 2 is a top view of a partial brake system.

FIG. 3A is a perspective view of a retraction spring assembly.

FIG. 3B is an opposing perspective view of the retraction spring assembly of FIG. 3A.

FIG. 4A is a perspective view of a pad clip.

FIG. 4B is a side view of the pad clip of FIG. 4A.

FIG. 5A is a plan view of a retraction spring.

FIG. 5B is a side view of the retraction spring of FIG. 5A.

FIG. 6A illustrates a perspective view of a retraction spring assembly from an interior of a brake system.

FIG. 6B illustrates a perspective view of a retraction spring assembly from an exterior of a brake system.

FIG. 7A illustrates a plan view of a brake system integrated with a wheel.

FIG. 7B illustrates a close-up view of a retraction spring assembly of FIG. 7A.

FIG. 8A illustrates a perspective view of a retraction spring assembly.

FIG. 8B illustrates an opposing perspective view of the retraction spring assembly of FIG. 8A.

FIG. 9A illustrates a plan view of a retraction spring.

FIG. 9B illustrates a side view of the retraction spring of FIG. 9A.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The present teachings provide a retraction spring assembly for use with a brake system in vehicles. The retraction spring assembly may be used with almost any brake system and the brake system may be used with almost any vehicle. A vehicle may include a car, truck, bus, train, airplane, or the like. Alternatively, the retraction spring assembly and brake system may be integrated into components used for manufacturing or other equipment that requires a brake, such as a lathe, winder for paper products or cloth, amusement park rides, or the like. The present teachings may be most suitable for use with a passenger vehicle, such as a car, truck, sports utility vehicle, or the like.

Generally, a disc brake system includes a caliper housing, a rotor, and two or more brake pads. The caliper housing is in communication with one or more inner brake pads and one or more outer brake pads located on opposing sides of the rotor. The brake pads may be held in communication with a support bracket of the caliper housing by one or more pad clips. A pad clip may be placed between each end of the brake pads and the support bracket. When one or more pad clips may be used, one pad clip may be used at each end of a brake pad so that the brake pad is maintained in communication with a support bracket. The retraction spring assembly of the present teachings may provide for a pad clip located at one end of the brake pads or at each end of the brake pads. For example, a brake system may include two pad clips or four pad clips. A pad clip may be part of a retraction spring assembly.

The retraction spring assembly of the disclosure includes a pad clip. The pad clip may function to connect at least a portion of a brake pad with a support bracket, retain a retraction spring, connect a retraction spring with at least a portion of a brake pad, or any combination thereof. The pad clip may be connected to at least a portion of a support bracket, brake pad, retraction spring, or any combination thereof. The pad clip may be connected to an abutment of a support bracket, an ear of a pressure plate, an anchor arm of a retraction spring, or any combination thereof. The pad clip may be sandwiched between a brake pad and a support bracket. The pad clip may include one or more walls, channels, flanges, stops, or any combination thereof. One or more walls may provide the general profile and/or shape of the pad clip. The one or more walls may form one or more channels. One or more flanges and/or stops may project from one or more walls. The pad clip may include or be free of a bridge. Being free of a bridge may allow individual pad clips to be located opposing of one another with the rotor gap therebetween. Being free of a bridge may allow for a plurality of pad clips to be utilized in a brake system without being constrained by a rotor gap width. One or more stops may function to locate a pad clip within a brake system, maintain the clip in place during a brake apply and/or brake release, or any combination thereof. One or more walls, flanges, and/or stops may be generally parallel, perpendicular, or any angle therebetween relative to one or more other walls, flanges, and/or stops. Generally parallel and/or generally perpendicular may mean within ten degrees of parallel and/or perpendicular. The pad clip may elastically and/or plastically deform upon engagement with a support bracket, brake pad, or both. The deformation may result in an increase and/or decrease in an angle between one or more walls, flanges, stops, or any combination thereof. The deformation may allow one or more channels to form a friction-fit with the support bracket, brake pad, or both. One or more walls may be generally planar, non-planar, or both. Non-planar may mean curved, bowed, indented, having one or more openings, the like, or any combination thereof. The pad clip may be formed as a one-piece or multi-piece component. The pad clip may include one or more channels for engaging with a support bracket, brake pad, retraction spring, or any combination thereof.

The pad clip may include one or more channels. The one or more channels may function to receive, engage, and/or be affixed to a portion of a caliper housing, support bracket, brake pads, retraction spring, or any combination thereof. The one or more channels may be formed by one or more walls. One or more channels may be adjacent to one or more other channels or distanced from one or more other channels. One or more channels may face (i.e., be open toward) an opposing and/or the same direction as one or more other channels. One or more channels may include a pad channel, support channel, or both. A support channel may receive an abutment of a support bracket, an anchor arm of a retraction spring, or both. A support channel may be sized to fixedly engage the abutment, anchor arm, or both. The support channel may be formed by generally opposing walls, converging walls, adjacent walls, or any combination thereof. An upper wall may be generally opposing (e.g., parallel) and/or converging toward a middle wall. An upper wall may converge toward a middle wall at an angle of about 2 degrees or more, about 5 degrees or more, about 7 degrees or more, or even about 10 degrees or more. An upper wall may converge a middle wall at about 50 degrees or less, about 40 degrees or less, about 30 degrees or less, or even about 20 degrees or less. The distance between the upper wall and the middle wall may be less than or about equal to a height of an abutment, anchor arm, or both to form an interference fit. The upper wall may be connected to the middle wall via a forward wall. The forward wall may adjacent to and/or integral with both the middle wall and the upper wall. The forward wall may form an angle relative to the upper wall, middle wall, or both. The forward wall may form an angle with the upper wall and/or middle wall of about 50 degrees or greater, about 60 degrees or greater, or even about 70 degrees or greater. The forward wall may form an angle with the upper wall and/or middle wall of about 110 degrees or less, about 100 degrees or less, or even about 90 degrees or less. For example, the forward wall may form an angle with the upper wall between about 60 degrees and about 80 degrees and the forward wall may form an angle with the middle wall between 80 degrees and about 100 degrees. When the support channel is assembled to a support bracket, a gap may be located between the forward wall and an abutment. The gap may receive an anchor arm. The gap may have a width about equal to or greater than a wire gauge of the retraction spring. Adjacent to the support channel may be the pad channel. The pad channel may receive an ear of a pressure plate of a brake pad. The pad channel may be sized to fixedly engage the ear. The pad channel may be formed of generally opposing walls, diverging walls, adjacent walls, or any combination thereof. A middle wall may be generally opposing (e.g., parallel) and/or diverging away from a bottom wall. The bottom wall may diverge at an angle relative to the middle wall of about 2 degrees or greater, about 5 degrees or greater, or even about 7 degrees or greater. The bottom wall may diverge at an angle relative to the middle wall of about 20 degrees or less, about 17 degrees or less, about 15 degrees or less, or even about 12 degrees or less. The distance between the middle wall and bottom wall may be less than or about equal to a height of the ear so the middle wall and bottom wall may form an interference fit with the ear. The middle wall may be connected to the lower wall via a rearward wall. The rearward wall may form an angle relative to the middle wall, lower wall, or both. The rearward wall may form an angle relative to the middle wall and/or lower wall of about 40 degrees or greater, about 55 degrees or greater, about 70 degrees or greater, about 80 degrees or greater, or even about 90 degrees or greater. The rearward wall may form an angle relative to the middle wall and/or lower wall of about 130 degrees or less, about 120 degrees or less, or even about 110 degrees or less. For example, the rearward wall may form an angle relative to the middle wall between about 70 degrees and 100 degrees and the rearward wall may form an angle relative to the lower wall between about 90 degrees and about 120 degrees. The rearward wall may be generally parallel or offset from the forward wall. The forward wall, rearward wall, or both may form an acute, perpendicular, and/or obtuse angle relative to the upper wall, middle wall, bottom wall, or any combination thereof. One or more walls upon engagement with a support bracket, brake pad, or both may deform such that an angle relative to one or more other walls increases and/or decreases. For example, a bottom wall may be generally perpendicular relative to a rearward wall prior to receiving an ear of a pressure plate and upon receiving the ear the angle may be obtuse.

The retraction spring includes a bias device. The bias device may function to store and/or release energy, assist in moving a retraction arm and/or brake pad, or any combination thereof. The bias device may store energy during a brake apply, release energy during a brake release, or both. The bias device may be any device which is able to provide a sufficient amount of force so that a brake pad is retracted when a brake apply is complete. The bias device may be any device that is elastically deformable and may assist in retracting a brake pad after a brake apply and/or during a brake release. The bias device may orient the brake pads against the fingers, the piston, or both so that the brake pads may be parallel to the rotor during running and/or during a brake apply. The bias device may pre-load the brake pads so that rattle is substantially reduced and/or eliminated during running. When the retraction spring is assembled with a pad clip, the bias device may be located adjacent to one or more walls (i.e., upper wall) and/or flanges of the pad clip, be free of contact and/or in contact with one or more walls, or both. When a retraction spring assembly is assembled with a brake system, the retraction spring may or may not extend further radially outward than one or more walls, channels, flanges, and/or stops of the pad clip and/or any portion of a brake pad, support bracket, caliper housing, or any combination thereof. For example, a bias device may be located radially outward relative to one or more walls (i.e., upper wall) of the pad clip. A profile of the caliper body may be located further radially outward than any portion, including the bias device, of the retraction spring assembly. As the bias device may be radially inward relative to the profile of the caliper housing, the retraction spring assembly may avoid interference with other portions of the brake system and/or vehicle components surrounding the brake system (e.g. wheels) and/or be protected from debris in this area (e.g. stones). A radial direction may be defined as a direction orthogonal to an axial direction defined by a rotational and/or longitudinal axis of a rotor. Radially outward may be defined as any direction away from a rotational and/or longitudinal axis. Radially inward may be defined as any direction toward a rotational and/or longitudinal axis.

The bias device may include and/or be one or more helical loops. The one or more helical loops may store energy during a brake apply, release energy during a brake release, or both. One or more helical loops may include a single helical loop or a plurality of helical loops. One or more helical loops may include one or more, two or more, or even three or more helical loops. One or more helical loops may include ten or less, eight or less, or even five or less helical loops. A plurality of helical loops may be successively stacked such that one loop is located directly adjacent another loop. One or more helical loops may form a coil having an axis. The axis may be a loop axis extending centrally through the one or more helical loops. A plurality of helical loops may be co-axial, may be staggered so that one or more helical loops are not co-axial, or both. One or more helical loops may be the same or a different size (e.g., width, diameter, circumference) as one or more other helical loops. The one or more helical loops may be any configuration where a portion of the retraction spring generally curves back over itself. The one or more helical loops may be configured so that each individual helical loop stores energy during a brake apply and releases energy when the brake apply is over (e.g., brake release) so that the energy is released and assists in retracting the brake pad. The one or more helical loops may be generally circular, oval, elliptical, or any combination thereof. Each of the helical loops may be moved so that the loops store energy during a brake apply.

One or more helical loops during a brake apply may move along an axis (i.e., the loop axis), may be compressed (i.e., diameter of a loop may be decreased), may be expanded (i.e., diameter of the loop may be increased), may be moved at an angle relative to the axis, or any combination thereof. The one or more helical loops during a brake apply may be axially stretched so that a full circumference of one or more helical loops is moved away from an adjacent helical loop, axially compressed so that a full circumference of one or more helical loops is moved toward an adjacent helical loop, or both. One or more helical loops during a brake apply may be compressed so that a size (e.g., diameter) of the one or more helical loops is reduced. The one or more helical loop during a brake release may be expanded so that the size (e.g., diameter) of the one or more helical loops is expanded. The one or more helical loops may be moved in a brake apply direction, brake release direction, or both. Part of or an entire coil of one or more helical loops may be moved in the brake apply direction, the brake release direction, or both. The one or more helical loops may be free of movement in the brake apply direction, brake release direction, or both. The one or more helical loops may be moved in a spring compression direction, a spring release direction, or both.

The one or more helical loops may define one or more axes, planes, or both. The one or more axes and/or planes may function to structurally relate one or more portions of the retraction spring assembly relative to one or more other portions. One or more axes, one or more planes, or both may be generally parallel with, perpendicular to, or any angle therebetween relative to one or more other planes, axes, or both. One or more of the axes may include a loop axis. The loop axis may be centered with and/or extend through one or more of the helical loops. The loop axes may be generally parallel to and/or lie within a transverse plane. The one or more planes may include a transverse plane, a median plane, a frontal plane, or any combination thereof. A transverse plane may function to divide the bias device and/or helical loops between an upper half and lower half. The loop axis and/or the transverse plane may be generally perpendicular relative to a median plane, frontal plane, or both. A median plane may intersect the frontal plane, such as at a perpendicular angle. A median plane may define a rotor side and an exterior side. A rotor side may be the side of the median plane closest to the rotor. An exterior side may be the side of the median plane opposing the rotor side. A frontal plane may be generally parallel with a diameter of one or more of the helical loops; perpendicular with a median plane, transverse plane, or both; or any combination thereof. A frontal plane may define a pad side and a support bracket side. A pad side may be the side of the frontal plane closest to a brake pad. A support bracket side may be the side of the frontal plane opposing the pad side, closest to a support bracket, or both.

The bias device may include one or more side arms. The side arms may function to connect the bias device to a retraction arm, anchor arm, or both; transfer energy stored and/or released in the bias device to and/or from the retraction arm, anchor arm, or both. The one or more side arms may include a support side arm, a pad side arm, or both. The one or more side arms may be integrally connected to and extend from the one or more helical loops. The one or more side arms may extend in a generally tangent or non-tangent direction relative to one or more of the helical loops. Non-tangent may include generally extending at any angle relative to the one or more loops. The angle may be parallel, perpendicular, or any angle therebetween. The one or more side arms may be formed at one or more locations where a portion of the retraction spring no longer curves back over itself. One or more side arms may be generally parallel, perpendicular, or any angle therebetween relative to one or more planes and/or axes. One or more side arms may be on, be generally parallel with, intersect, extend away, and/or extend toward opposing and/or the same sides of the bias device, one or more planes, or both as one or more other side arms. A support side arm may be on the same side of a transverse plane as a pad side arm. The support side arm, pad side arm, or both may be generally parallel with a transverse plane. A support side arm may be on an opposing and/or same side of a median plane and/or frontal plane as a pad side arm. When the retraction spring assembly is installed with a brake system, a pad side arm may be located on a rotor side of a median plane, extend toward a brake pad, extend toward a rotor, extend in a brake apply direction, or any combination thereof. When the retraction spring assembly is assembled to a brake system, a pad side arm may be located on an exterior side of a median plane, extend away from a rotor, extend toward a support bracket, extend in a brake release direction, or any combination thereof. The support side arm may be integrally connected to an anchor arm.

The retraction spring may include an anchor arm. The anchor arm may function to form a fixed connection with a pad clip, extend into a channel of the pad clip, reside between a pad clip and a support bracket, provide a reaction point against tension in a bias device, or any combination thereof. The anchor arm may be configured so that during a brake apply, the force of one or more brake pads in the brake apply direction assists in maintaining a connection between the anchor arm and the pad clip. During each brake apply, the anchor arm may provide a reaction point to create tension within a bias device. The tension may be a result of the anchor arm remaining fixed within a channel during a brake apply while the retraction arm is pulled toward a rotor. The tension during a brake apply may be created by a retraction arm pulling at and/or compressing the bias device and/or anchor arm so that the bias device may elastically deform and store energy. To provide tension within the bias device, the anchor arm may be attached and/or integrally connected to a bias device via a side arm, such as a support side arm. The one or more anchor arms may reside within a channel and/or gap within a channel of a pad clip. A gap may be formed within the support channel between a wall of the support channel and a support bracket. The anchor arm may rest between an abutment of the support bracket and a forward wall of the support channel. The contact of the abutment and forward wall with the anchor arm may retain the retraction spring within the pad clip, prevent rotation of the retraction spring about the anchor arm, retain the bias device free of contact with the pad clip by restricting movement of the anchor arm, or any combination thereof. The one or more anchor arms may form a fixed connection with a channel of the pad clip, such as the support channel. The one or more anchor arms may exert a force on an inside of a channel of the pad clip. The force exerted by the one or more anchor arms may retain the anchor arm within the channel. The force created by the one or more anchor arms may be sufficiently large so that the one or more anchor arms retain the retraction spring in contact with one or more walls of a channel of the pad clip. The force may be created by a bias lock of the anchor arm. The one or more anchor arms may include one or more segments and/or elbows which contact opposing walls of a channel, such as walls which are generally parallel and/or converge toward one another (i.e., the upper wall and the middle wall). The anchor arm may rest between and be in contact with an upper wall and a middle wall. The contact of the upper wall and middle wall with the anchor arm may retain the retraction spring within the pad clip, prevent rotation of the retraction spring about the anchor arm, retain the bias device free of contact with the pad clip by restricting movement of the anchor arm, or any combination thereof. The one or more anchor arms may extend outside of a channel of the pad clip, be located entirely within a channel of the pad clip, form a connection with a forward wall, form a connection with an abutment, or any combination thereof. The anchor arm may be located on a same or opposing side of one or more planes and/or axes as a retraction arm, bias device, or both. For example, the anchor arm may be located on a same side of a transverse plane as one or more side arms, a retraction arm, or both. The anchor arm may or may not intersect one or more planes and/or axes. The anchor arm may not intersect a transverse plane and/or frontal plane. The anchor arm may or may not intersect a median plane. The anchor arm may extend away from one or more planes. The anchor arm may extend away from a frontal plane. The anchor arm may extend away from the frontal plane at an angle relative to the frontal plane of about 2 degrees or greater, about 5 degrees or greater, about 7 degrees or greater, or even about 10 degrees or greater. The anchor arm may extend away from the frontal plane at an angle relative to the frontal plane of about 65 degrees or less, about 50 degrees or less, about 40 degrees or less, about 25 degrees or less, about 20 degrees or less, or even about 15 degrees or less.

The retraction spring may include one or more elbows and/or segments. The one or more elbows and/or segments may function to integrally connect one or more portions of the retraction spring with one or more other portions, extend the portions toward differing directions, or both. The one or more elbows and/or segments may form a retraction arm, anchor arm, or both. One or more elbows and/or segments may include a transfer elbow, transfer segment, contact elbow, contact arm, connection elbow, connection segment, lower elbow, lower segment, upper elbow, upper segment, or any combination thereof. The one or more elbows and/or segments may be generally linear, curved, angled, or any combination thereof. One or more elbows may integrally connect one or more segments, angle one or more segments relative to another segment, or both. One or more segments and/or elbows may be generally parallel, perpendicular, or any angle therebetween relative to one or more other segments, elbows, side arms, planes, axes, or any combination thereof. The angle between one or more segments, elbows, side arms, planes, axes, or any combination thereof may be generally acute, a right angle, and/or obtuse. One or more segments and/or elbows may integrally connect an anchor arm, retraction arm, or both to a bias device. One or more segments and/or elbows may be integrally connected to one or more side arms. One or more segments and/or elbows may extend away from and/or towards a bias device, one or more planes, one or more axes, other segments, other elbows, or any combination thereof. One or more elbows and/or segments of an anchor arm may form a bias lock.

The retraction spring may include a bias lock. The bias lock may function to assist the anchor arm in creating a force within a channel of the pad clip, maintaining the anchor arm fixed within a channel of the pad clip, or both. The bias lock may be any size and/or shape to create the force within the channel. The bias lock may create a holding force and an opposing holding force within the channel of the pad clip so that the anchor arm connects the retraction spring to the pad clip. The bias lock may bias one or more segments and/or elbows of an anchor arm toward one or more walls of the channel. The bias lock may bias one or more segments toward an upper wall, middle wall, or both to form a holding force, an opposing holding force, or both. The bias lock may include one or more segments, elbows, arcuate portions, curved portions, a portion that connects to adjacent segments of an anchor arm, or a combination thereof. The bias lock may be formed by an upper segment, upper elbow, and lower segment of an anchor arm. The bias lock may act as a spring, a cantilever connection, or both. The bias lock may have a general C-shape, U-shape, J-Shape, S-Shape, M-shape, N-Shape, or any combination thereof. The bias lock may bias two or more adjacent portions of an anchor arm so that the bias lock assists in connecting the retraction spring with a channel of the pad clip. The bias lock may bias an upper segment toward an upper wall and a lower segment toward a middle wall. The bias lock may produce sufficient force so the retraction spring is connected to the pad clip.

The bias lock may produce any force so that the retraction spring is retained within a brake system, in contact with the pad clip and/or a channel of the pad clip, fixed to the pad clip and/or channel of the pad clip or any combination during running, a brake apply, a brake release, or any combination thereof. The bias lock may create a gripping force, a spread force, or a combination of both. The force may be two opposing forces (i.e., a holding force, an opposing holding force) that connect the retraction spring to a brake component, the pad clip, and/or a channel of the pad clip. The holding force, the opposing holding force, or both may be greater than 0 N, about 0.1 N or greater, about 1 N or greater, about 5 N or greater, about 10 N or greater, or even about 15 N or greater. The holding force, the opposing holding force, or both may be about 50 N or less, about 40 N or less, about 30 N or less, or even about 20 N or less. The holding force may be applied to a part of the pad clip and the opposing holding force may be applied to a generally opposing part of the pad clip and/or opposing the holding force. The holding force, the opposing holding force, or both may be created on any part of the pad clip, the support bracket, the abutment, a channel of the pad clip, or any combination thereof so that the retraction spring is retained within the brake system. The bias lock may assist in retaining an anchor arm within the support channel when a retraction arm is moved in a brake apply and/or brake release direction.

The retraction spring may include a retraction arm. The retraction arm may function to assist in forming a connection with one or more brake pads, retracting one or more brake pads, transferring energy to and/or from a bias device, or any combination thereof. The retraction arm may be any size and shape so that the retraction arm extends between a brake pad and the bias device so that during a brake apply energy from movement of the brake pad may be transferred to the bias device and during a brake release the energy may be transferred back to the brake pad so that the brake pad is retracted. The retraction arm may extend so that a portion of the retraction arm extends over the brake pad, under the brake pad, over an ear of the brake pad, under an ear of the brake pad, between a brake pad and a rotor, into contact with a bore in the pressure plate of the brake pad, to the side of the pressure plate proximate to the friction material, or any combination thereof. The retraction arm may include one or more segments and/or elbows. The retraction arm may include a single segment or a plurality of segments. The plurality of segments may be connected by one or more elbows to allow a segment to be angled relative to another segment. The retraction arm may be integrally connected with a bias device, one or more side arms, or both. The retraction arm may be integrally connected with the bias device via a side arm. The retraction arm may be located on a same and/or opposing side of one or more planes and/or axes as one or more side arms, the anchor arm, or both. For example, the retraction arm may be located on a same side of a transverse plane as one or more side arms, an anchor arm, or both. The retraction arm may extend away from the bias device. The retraction arm may generally extend away from, extend toward, intersect, and/or be free of intersecting with one or more planes and/or one or more axes. The retraction arm may extend away from and/or be free of intersecting a transverse plane, a frontal plane, or both. A portion of a retraction arm may be generally parallel (e.g., free of intersecting) with a frontal plane. A portion of a retraction arm may extend away from a frontal plane at an angle relative to the frontal plane of about 2 degrees or more, about 5 degrees or more, about 7 degrees or more, or even about 10 degrees or more. A portion of a retraction arm may extend away from a frontal plane at an angle relative to the frontal plane of about 25 degrees or less, about 20 degrees or less, or even about 15 degrees or less. The retraction arm may extend toward and/or intersect a median plane, frontal plane, or both. The retraction arm may or may not intersect one or more planes and/or axes.

The retraction spring may include a contact arm. The contact arm may form a connection between the one or more brake pads and the retraction spring, applying a force to the one or more brake pads to assist in retracting the one or more brake pads, receiving a force from the one or more brake pads to receive and transfer energy to a bias device, or any combination thereof. The contact arm may be any device that may contact a portion of one or more brake pads, one or more pressure plates of one or more brake pads, a bore in one or more brake pads, or any combination thereof. The contact arm may form a fixed connection with an ear of a brake pad. The contact arm may grip and/or be in direct contact with a portion of a brake pad, a pressure plate, wrap around a brake pad, extend to a friction side of a pressure plate, or any combination thereof. The contact arm may be part of or connected to a retraction arm. The contact arm may be connected to one or more segments (e.g., a transfer segment) of a retraction arm. The contact arm may be connected to one or more segments via one or more elbows (e.g., contact elbow). The contact arm and the one or more segments may form an angle therebetween. The angle between the contact arm and a segment of the anchor arm may be about 180 degrees or less, about 170 degrees or less, or even about 160 degrees or less. The angle between the contact arm and a segment of the anchor arm may be about 45 degrees or more, about 90 degrees or more, or even about 110 degrees or more. The contact arm may extend toward, extend away from, intersect, and/or be free of intersecting one or more planes and/or axes of the retraction spring. The contact arm may extend away from a transverse plane, a median plane, a frontal plane, or any combination thereof. The contact arm may extend toward the median plane at an angle relative to the median plane of about 0 degrees or greater, about 5 degrees or greater, about 10 degrees or greater, or even about 15 degrees or greater. The contact arm may extend toward the median plane at angle relative to the median plane of about 90 degrees or less, about 75 degrees or less, about 60 degrees or less, or even about 50 degrees or less. These angles may be inclusive of angles of the contact arm relative to the median plane when the retraction spring assembly is part of a brake system or separate from (i.e., prior to assembly with) the brake system. The angle of the contact arm relative to the median plane may differ when the retraction spring assembly is assembled with a brake system compared to being separate from the brake system. While assembled with a brake assembly, the contact arm may extend toward the median plane at an angle less than or about equal to than when separate from the brake system. The contact arm may extend toward a median plane, a frontal plane, or both. The contact arm may or may not intersect (i.e., pass through) a median plane, frontal plane, or both. When a retraction spring is assembled onto a pad clip, the contact arm may angle toward the pad clip. The contact arm may angle toward one or more walls of the pad clip (e.g., the rearward wall). The contact arm may be a single arm or a plurality of arms extending from a segment of a retraction arm.

The retraction spring may deform as the brake pads wear. The deformation may be elastic deformation. For example, the shape of the retraction spring may not permanently change as the brake pads wear, but the retraction spring may elastically deform so that the retraction spring remains in contact with the brake pad as the friction material wears, and assists in returning the brake pad substantially back to their pre-brake position so that a constant air gap is maintained. Air gap may be a total distance between a face of an inner brake pad and a face of an outer brake pad minus the thickness of a rotor when the inner brake pad contacts the caliper piston and the outer brake pad contacts the caliper housing fingers. The air gap may be a distance between the outer surface of a rotor and the face of the outer brake pad when the inner brake pad is pushed into contact with the inner surface of the rotor and when the inner brake pad contacts the piston and the outer brake pad contacts the fingers. The air gap may be any size that allows for braking. The air gap may be any size that does not cause the brake pedal to have a soft feel or a long travel. The air gap will be small (e.g., between about 0.05 mm to about 0.5 mm). The deformation may be plastic deformation. As the brake pads wear, the retraction spring may change shape so that as the friction material wears the retraction of the brake pad is less but the air gap is maintained at substantially the same distance. As the retraction spring plastically deforms, the force exerted against each brake pad will remain substantially constant.

The retraction spring may exert a force axially, in relationship to the rotor, in the brake release direction. The retraction spring may apply any amount of force which assists the one or more brake pads in moving axially, relative to the rotor, after a brake apply. If a plurality of retraction spring assemblies are installed in a brake system, each of the retraction springs may exert substantially the same force on each of the respective brake pads. The one or more retraction springs may each exert an axial force in the brake release direction of about 5 N or greater, about 10 N or greater, about 15 N or greater, about 20 N or greater, about 25 N or greater, or even about 30 N or greater. The one or more retraction springs may each exert an axial force in the brake release direction of about 50 N or less, about 45 N or less, about 40 N or less, or even about 35 N or less. Four retraction springs may be used (i.e., one on each side of each of the brake pads). Each retraction spring may exert an axial force in the brake release direction. For example, one retraction spring may exert a force of about 20 N and two retraction springs may exert a force of about 40 N on each brake pad. Two retraction springs may exert a force of about 10 N or greater, about 20 N or greater, about 30 N or greater, about 40 N or greater, about 50 N or greater, or even about 60 N or greater. Two retraction springs may exert a force of about 100 N or less, about 90 N or less, about 80 N or less, or even about 70 N or less. The brake may include an inner brake pad and an outer brake pad. The one or more retraction springs may apply substantially the same amount of force to both brake pads in the brake release direction.

The retraction spring may be made of any material that may be formed and may exert a force when compressed. The retraction spring may be made of and/or include one or more polymeric materials, metals, or any combination thereof. The retraction spring may be made of any one or more metals which exhibit good plastic deformation and good elastic deformation characteristic. The one or more metals may comprise stainless steel. The retraction spring may be made of a wire, sheet, band, tube, pipe, or the like. The material may be any gauge which assists in moving the one or more brake pads in the retract or release direction. The material may be any size which allows the retraction spring to exert a desired force. The material may be any size (e.g., thickness, diameter, gauge, length, width, or the like) that allows the retraction spring to assist in pad retraction. The wire may be about 0 gauge or more, about 3 gauge or more, about 5 gauge or more, or even about 10 gauge or more. The wire may be about 30 gauge or less, about 25 gauge or less, or even about 20 gauge or less.

### Illustrative Embodiments

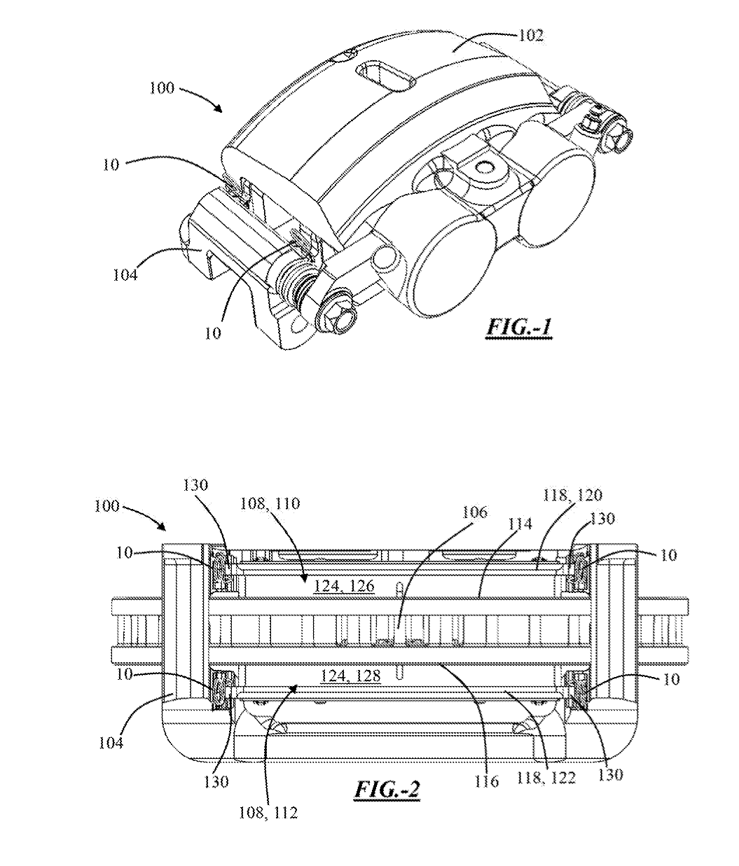

FIG. 1 illustrates a perspective view of a brake system 100. The brake system 100 includes a caliper housing 102 affixed to a support bracket 104. Located between the caliper housing 102 and the support bracket 104 is a plurality of retraction spring assemblies 10.

FIG. 2 illustrates a top view of a brake system 100 without a caliper housing 102 (not shown). The brake system 100 includes a support bracket 104 and a rotor 106. The support bracket 104 includes a pair of opposing brake pads 108 with the rotor 106 therebetween. The brake pads 108 includes inner brake pads 110 and outer brake pads 112. The inner brake pads 110 are adjacent to an inner surface 114 of the rotor 106 and the outer brake pads 112 are adjacent to an outer surface 116 of the rotor 106. Each of the brake pads 108 includes a pressure plate 118. The inner brake pad 110 includes an inner pressure plate 120 and the outer brake pad 112 includes an outer pressure plate 122. The brake pads 108 include a friction material 124 adjacent to a respective pressure plate 118. The friction material 124 includes an inner friction material 126 and an outer friction material 128. The inner friction material 126 is affixed to the inner pressure plate 120 and the outer friction material 128 is affixed to the outer pressure plate 122. Movement of the brake pads 108 toward the rotor 106 results in a brake force being created. The pressure plates 118 include ears 130 at opposing ends. Each ear 130 extends into contact with a retraction spring assembly 10.

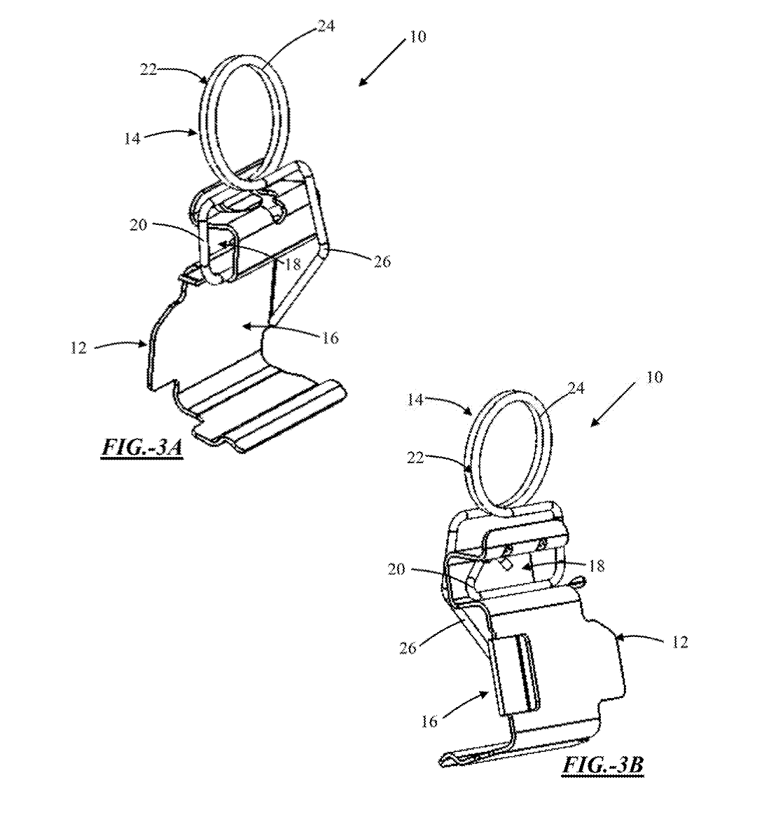

FIGS. 3A and 3B illustrate a retraction spring assembly 10. The retraction spring assembly 10 includes a pad clip 12 and a retraction spring 14. The pad clip 12 includes a pad channel 16. The pad channel 16 is adapted to receive a portion of a brake pad 108 (not shown). The pad clip 12 includes a support channel 18. The support channel 18 is adjacent to the pad channel 16. The support channel 18 is adapted to receive a portion of a support bracket 104 (not shown). The support channel 18 engages the retraction spring 14. The retraction spring 14 includes an anchor arm 20. The anchor arm 20 resides within the support channel 18. The anchor arm 20 is connected to a bias device 22. The bias device 22 is comprised of a plurality of helical loops 24. The helical loops 24 are located adjacent to the support channel 18. The helical loops 24 are free of contact with the pad clip 12. The bias device 22 is free of constraint by the pad clip 12. Integral with the bias device 22 is a retraction arm 26.

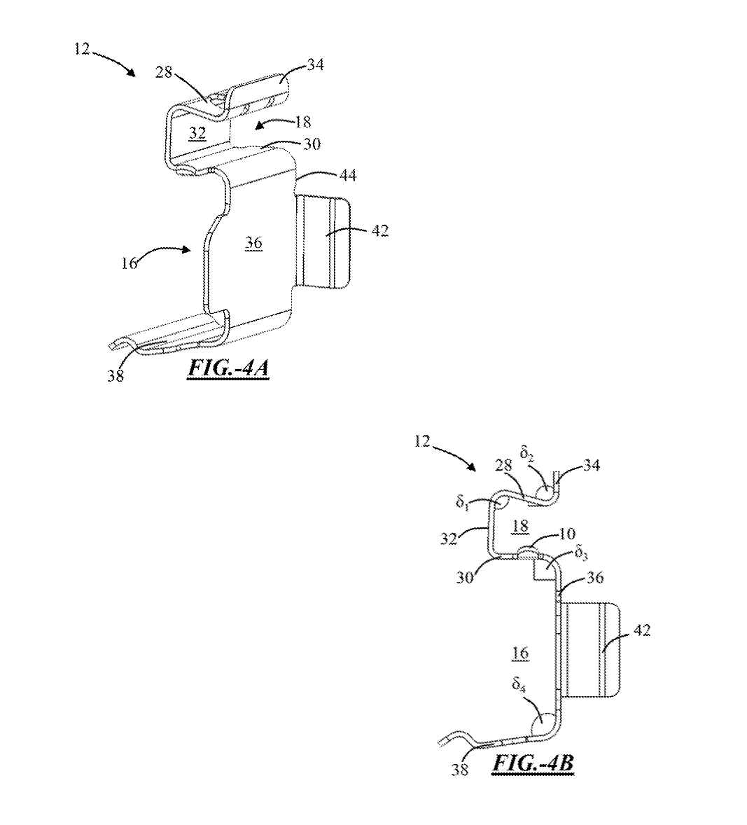

FIGS. 4A and 4B illustrate a pad clip 12. The pad clip 12 includes a support channel 18. The support channel 18 is adapted to receive an abutment 132 (not shown) of a support bracket 104 (not shown) and an anchor arm 20 (not shown). The support channel 18 includes an upper wall 28 and a middle wall 30. The upper wall 28 is connected to the middle wall 30 via a forward wall 32. The upper wall 28 is generally at an acute angle δ₁ relative to the forward wall 32 such that the upper wall 28 angles toward the middle wall 30 as it projects away from the forward wall 32. The acute angle δ₁ as shown may be the angle when the pad clip is installed and engaged with a brake system or may be an angle of the pad clip when separate from a brake system. Extending from the upper wall 28 is an upper flange 34. The upper flange 34 is located at an opposite end of the upper wall 28 as the forward wall 32. The upper flange 34 projects from the upper wall 28 in an opposite direction as the forward wall 32. The upper flange 34 is generally at an acute angle δ₂ relative to the upper wall 28. The upper flange 34 is generally parallel with the forward wall 32. Also, when the pad clip 12 is installed in a brake caliper, generally parallel to the forward wall 32 is a rearward wall 36. The rearward wall 36 is located at an opposite end of the middle wall 30 as the forward wall 32. The rearward wall 36 is at a generally perpendicular angle δ₃ relative to the middle wall 30. Projecting from the rearward wall 36 is a lower wall 38. The lower wall 38 is at a generally obtuse angle δ₄ relative to the rearward wall 36. Projecting from the rearward wall 36 is an internal stop 42. The internal stop 42 assists in locating the pad clip 12 to the support bracket 104 and retaining the pad clip 12 in place on the support bracket 104. The internal stop 42 projects from an edge 44 of the rearward wall 36 between the middle wall 30 and lower wall 38. The cavity formed by the middle wall 30, rearward wall 36, and lower wall 38 is the pad channel 16. The pad channel 16 is adapted to receive an ear 130 (not shown) of a brake pad 108 (not shown).

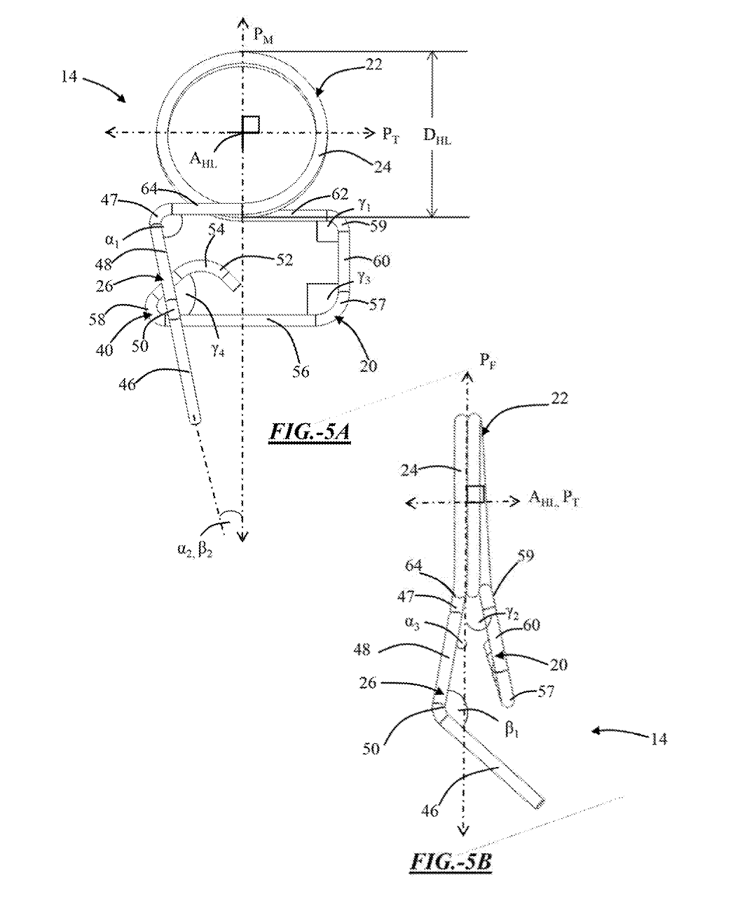

FIGS. 5A and 5B illustrate a retraction spring 14. The retraction spring 14 is shown as if it was under tension and installed to the pad clip 12 (not shown). The retraction spring 14 includes a bias device 22. The bias device 22 includes a plurality of helical loops 24. The helical loops 24 are grouped in a single coil. A loop axis A_{HL} passes concentrically through the plurality of helical loops 24. The loop axis A_{HL} is parallel with a transverse plane P_{T}. The loop axis A_{HL} lies in the transverse plane P_{T}. The transverse plane P_{T} and the loop axis A_{HL} are generally perpendicular to a median plane P_{M}. The loop axis A_{HL} and the median plane P_{M} are perpendicular to a frontal plane P_{F}. The bias device 22 further includes opposing arms, a support side arm 62 and a pad side arm 64. Both the support side arm 62 and the pad side arm 64 are integrally connected with the helical loops 24. The support side arm 62 and pad side arm 64 are located at opposing ends of the helical loops 24. The support side arm 62 extends away from the helical loops 24 in a direction tangent to a diameter D_{HL} of the helical loops 24. The support side arm 62 extends away from the helical loops 24 away from the median plane P_{M}. The support side arm 62 extends away from the helical loops generally parallel with the transverse plane P_{T}. The pad side arm 64 extends away from the helical loops 24 in a direction tangent to a diameter D_{HL} of the helical loops 24. The pad side arm 64 extends away from the helical loops 24 in a direction generally opposite the support side arm 62. The pad side arm 64 extends away from the helical loops 24 away from the median plane P_{M}. The pad side arm 64 extends away from the helical loops generally parallel with the transverse plane P_{T}. The support side arm 62 and pad side arm 64 are located on a same side of the transverse plane P_{T}. When assembled in a brake system 100 (not shown), the pad side arm 64 is located on a rotor side of the median plane P_{M} while the support side arm 62 is located on the opposing, exterior side of the median plane P_{M}. The support side arm 62 and pad side arm 64 integrally connect the helical loops 24 with both an anchor arm 20 and a retraction arm 26.

The retraction spring 14 includes a retraction arm 26. The retraction arm 26 is adapted for transferring energy to and from the bias device 22. The retraction arm 26 is integrally connected to the bias device 22 at the pad side arm 64. The retraction arm 26 is located entirely on a same side of the transverse plane P_{T} as the pad side arm 64. The retraction arm 26 extends away from the bias device 22 and the transverse plane P_{T}. The retraction arm 26 does not approach or intersect the transverse plane P_{T}. The retraction arm 26 includes a transfer segment 48, a contact elbow 50, and a contact arm 46. The transfer segment 48 is integrally connected to the bias device 22 via a transfer elbow 47. The transfer segment 48 is generally at an acute angle α₁ relative to the pad side arm 64. The transfer segment 48 projects away from the bias device 22 and the transverse plane P_{T}. The transfer segment 48 angles toward the median plane P_{M} at acute angle α₂ as the transfer segment 48 extends away from the bias device 22. The transfer segment 48 angles away from a frontal plane P_{F} at acute angle α₃ as the transfer segment 48 projects away from the bias device 22. The transfer segment 48 is integrally connected to the contact arm 46 via the contact elbow 50. The contact arm 46 is generally at an obtuse angle β₁ relative to the transfer segment 48. The contact arm 46 angles away from the transfer segment 48 such that the contact arm 46 angles toward and intersects the frontal plane P_{F}. The contact arm 46 approaches the median plane P_{M} at an acute angle β₂ which is about equal to the acute angle α₂ at which the transfer segment 48 approaches the median plane P_{M}. The contact arm 46 is skewed (i.e., not parallel) relative to the transverse plane P_{T}. The contact arm 46 is adapted to be in direct contact with a pressure plate 118 (not shown) of a brake pad 108 (not shown).

The retraction spring 14 includes an anchor arm 20. The anchor arm 20 is adapted for residing within a gap between a support channel 18 (not shown) of a pad clip 12 (not shown) and a support bracket 104 (not shown) and engaging the retraction spring 14 with the pad clip 12 (not shown). The anchor arm 20 is integrally connected to the bias device 22 at the support side arm 62. The anchor arm 20 is located entirely on a same side of the transverse plane P_{T} as the support side arm 62 and the retraction arm 26. The anchor arm 20 includes a connection segment 60, lower elbow 57, lower segment 56, upper elbow 58, and upper segment 52. The connection segment 60 is integrally connected to the bias device 22 via a connection elbow 59. The connection segment 60 is generally perpendicular γ₁ relative to the support side arm 62. The connection segment 60 extends away from the bias device 22 and the transverse plane P_{T}. The connection segment 60 is generally parallel with the median plane P_{M}. The connection segment 60 angles away from the frontal plane P_{F} at acute angle γ₂ as the connection segment 60 projects away from the bias device 22. The connection segment 60 is connected to the lower segment 56 via a lower elbow 57. The lower segment 56 is generally perpendicular γ₃ to the connection segment 60. The lower segment 56 is substantially parallel with transverse plane P_{T} and the support side arm 62. The lower segment 56 is integrally connected with an upper segment 52 via an upper elbow 58. The upper segment 52 extends away from the upper elbow 58 toward the median plane P_{M} and the connection segment 60. The upper segment 52 extends away from the upper elbow 58 at generally an acute angle γ₄ relative to the lower segment 56. The upper segment 52 is curved. The curvature is such that an apex 54 of the upper segment 52 is closer to the bias device 22 than other portions of the upper segment 52. The anchor arm 20 has a general J-shape formed by the upper segment 52, upper elbow 58, and lower segment 56. The upper segment 52, upper elbow 58, and lower segment 56 form the bias lock 40 of the anchor arm 20.

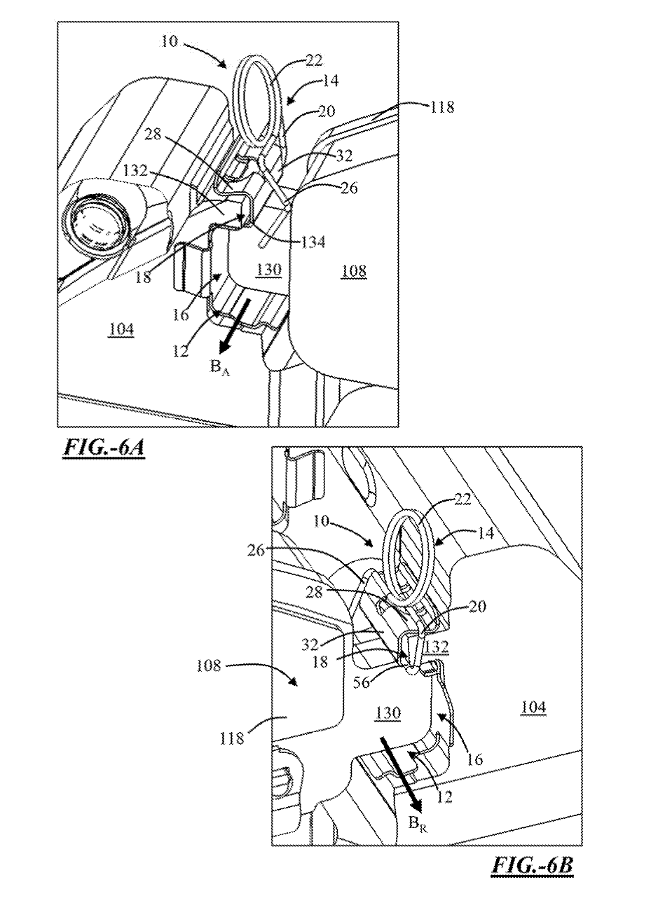

FIGS. 6A and 6B illustrate a retraction spring assembly 10 attached to both a brake pad 108 and a support bracket 104. The retraction spring assembly 10 includes a pad clip 12 and a retraction spring 14. The pad clip 12 is sandwiched between the brake pad 108 and the support bracket 104. The pad clip 12 includes a support channel 18. The support channel 18 receives an abutment 132 projecting from the support bracket 104. A gap 134 is located between the forward wall 32 and the abutment 132. A portion of the anchor arm 20 extends into the gap 134. A portion of the anchor arm 20 is located between the abutment 132 and the forward wall 32. The upper segment 52 (not shown) is in contact with the upper wall 28 while the lower segment 56 is in contact with the middle wall 30 (not shown). The upper segment 52 (not shown) and lower segment 56 of the anchor arm 20 are located between the abutment 132 and the forward wall 32 so that the retraction spring 14 is prevented from rotating about the anchor arm 20. By preventing rotation, the bias device 22 remains adjacent to the upper wall 28 of the pad clip 12 while being free of contact with the pad clip 12. The upper segment 52 (not shown) and lower segment 56 may be in contact with the abutment 132 and/or forward wall 32, as shown, or may be free of contact with the abutment 132 and/or forward wall 32. The pad clip 12 includes a pad channel 16. The pad channel 16 receives an ear 130 of a pressure plate 118. A retraction arm 26 extending from a bias device 22 is in contact with the ear 130. Movement of the ear 130 toward a rotor 106 (not shown) during a brake apply (shown by direction B_{A}) results in the ear 130 applying an inwardly force to and moving the retraction arm 26 toward the rotor 106 (not shown). The retraction arm 26 transfers the force into the bias device 22 which stores it as potential energy. During a brake release, the retraction arm 26 transfers the stored energy from the bias device 22 back into the ear 130 so that the ear 130 moves away from the rotor 106 (as shown by direction B_{R}). Since the retraction arm 26 is in contact with the ear 130, as the retraction arm 26 moves away from the rotor 106 (not shown) the retraction arm 26 applies an outwardly force to the ear 130 resulting in the ear moving away from the rotor 106.

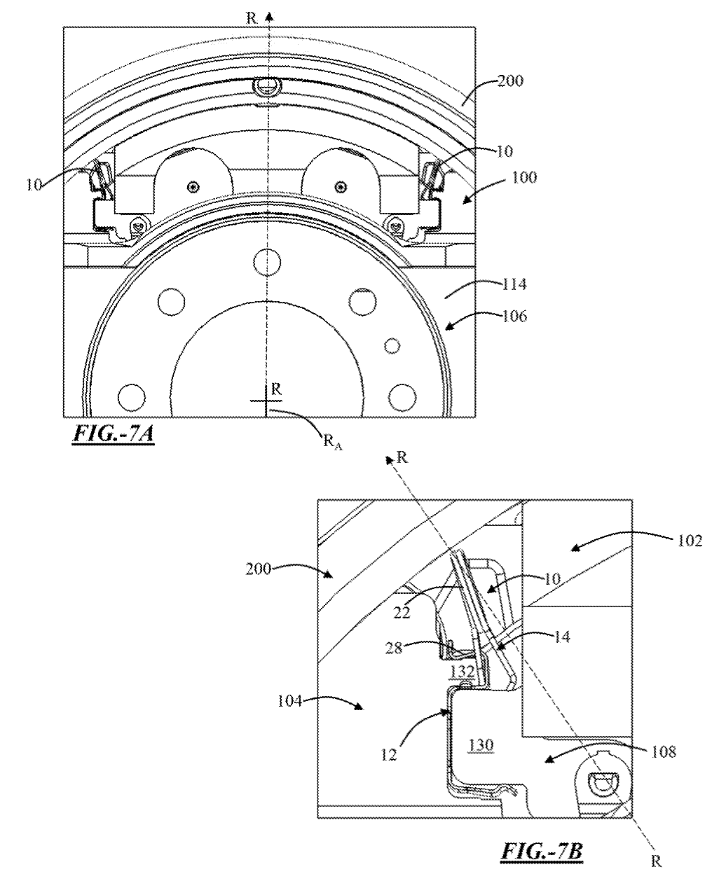

FIG. 7A illustrates a plan view of a brake system 100 assembled to a wheel 200, such as through a knuckle (not shown) and the rotor 106. The brake system 100 includes a plurality of retraction spring assemblies 10. The brake system 100 includes a rotor 106 which rotates about a rotational axis R_{A}. The rotational axis R_{A} is substantially orthogonal to an inner surface 114 of the rotor 106. The rotor 106 defines a radial direction R-R which is perpendicular to the rotational axis R_{A}. A radially outward direction is defined when the radial direction R-R is followed away from the rotational axis R_{A}. A wheel 200 is located radially outward from the retraction spring assemblies 10.

FIG. 7B illustrates a close-up view of a retraction spring assembly 10 of FIG. 7A. A pad clip 12 receives both an ear 130 of a brake pad 108 and an abutment 132 of a support bracket 104. A retraction spring 14 connected to the pad clip 12 extends further radially outward than both the ear 130 and the abutment 132. The retraction spring 14 extends further radially outward than any surface of the pad clip 12. A bias device 22 of the retraction spring 14 is located radially outward from an upper wall 28 of the pad clip 12. Both the caliper housing 102 and support bracket 104 extend further radially outward than the retraction spring 14, including the bias device 22. As the retraction spring 14 is radially inward from the caliper housing 102 and support bracket 104, the retraction spring 14 does not interfere with the wheel 200.

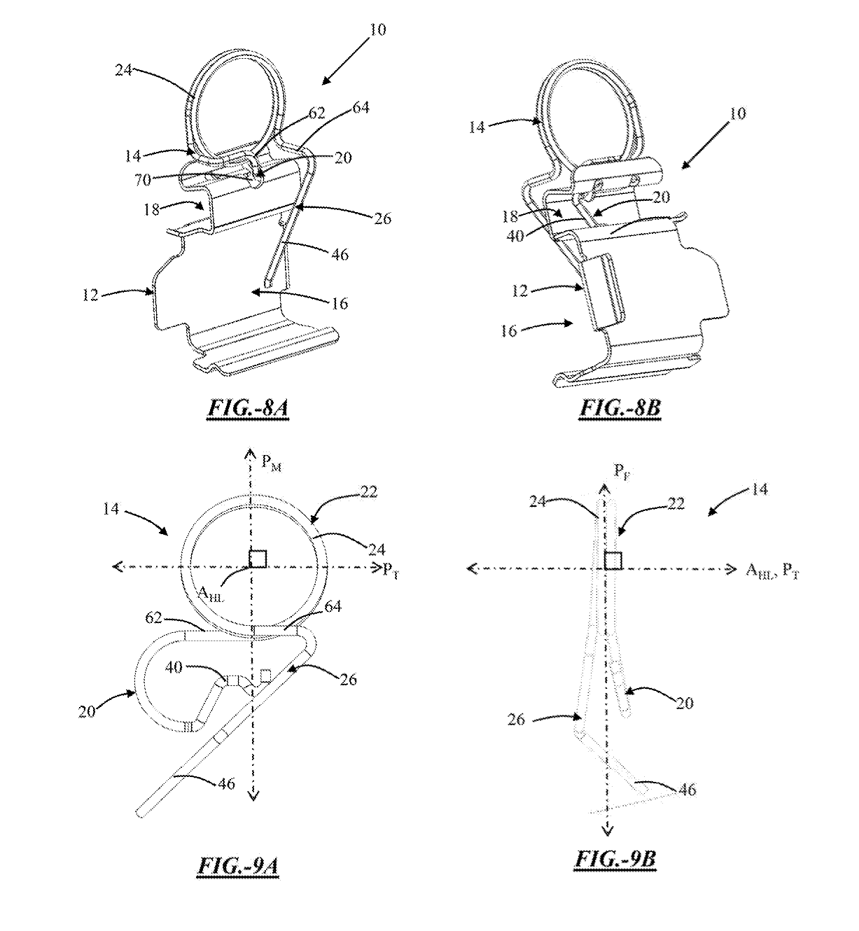

FIGS. 8A and 8B illustrate a retraction spring assembly 10. The retraction spring assembly 10 includes a pad clip 12 and a retraction spring 14. The pad clip 12 includes a pad channel 16 adjacent to a support channel 18. An anchor arm 20 is located within the support channel 18. A bias lock 40 engages the anchor arm 20 within the support channel 18. The bias lock 40 has an S-like shape. The anchor arm 20 is integral with helical loops 24 via a support side arm 62. The anchor arm 20 passes through an opening 70. A retraction arm 26 is integral with helical loops 24 via a pad side arm 64. The retraction 26 arm includes a linear contact arm 46.

FIGS. 9A and 9B illustrate a retraction spring 14. The retraction spring 14 is shown as if were under tension installed to the pad clip 12 (not shown). The retraction spring 14 includes a bias device 22. The bias device 22 includes helical loops 24. A loop axis A_{HL} extends through the helical loops 24. The loop axis A_{HL} is parallel with and lies within a transverse plane P_{T}. Extending from the helical loops 22 are opposing side arms 62, 64. The opposing side arms include a support side arm 62 and a pad side arm 64. The opposing side arms 62, 64 are located on opposing sides of both the median plane P_{M} and frontal plane P_{F}. The support side arm 62 is integrally connected with an anchor arm 20. The anchor arm 20 includes a bias lock 40. The pad side arm 64 is integrally connected with a retraction arm 26. The retraction arm includes a contact arm 46.

As used herein, unless otherwise stated, the teachings envision that any member of a genus (list) may be excluded from the genus; and/or any member of a Markush grouping may be excluded from the grouping.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.” Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for aid purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist of, or consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the disclosure should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A retraction spring comprising:
a) a bias device which stores energy during a brake apply and releases the energy during a brake release, the bias device having:
(i) one or more helical loops having a loop axis extending therethrough and concentric with a diameter of the one or more helical loops and a first end opposite a second end;
(ii) a pad side arm located at the first end of the one or more helical loops; and
(iii) a support side arm located at the second end of the one or more helical loops;
b) an anchor arm integrally attached at the support side arm of the bias device, the anchor arm connecting the retraction spring to a brake component;
c) a retraction arm integrally attached at the pad side arm of the bias device;
wherein the loop axis lies within and is generally parallel to a transverse plane, and wherein a median plane is generally perpendicular to the transverse plane and also intersects the loop axis;
wherein the pad side arm, the support side arm, the anchor arm, and the retraction arm are located on a same side of the transverse plane;
wherein the anchor arm intersects the median plane so that the anchor arm is located one both sides of the median plane;
wherein during the brake apply, movement of the retraction arm is away from the bias device, away from the anchor arm, and/or toward a rotor and results in the energy being stored in the bias device; and
wherein during the brake release, the energy stored in the bias device is released and transferred to the retraction arm to result in movement of the retraction arm toward the bias device, toward the anchor arm, and/or away from the rotor.

2. The retraction spring of claim 1, wherein the retraction arm extends away from the bias device and the transverse plane and angles toward the median plane.

3. The retraction spring of claim 2, wherein a frontal plane is perpendicular to both the transverse plane and the median plane;
wherein the retraction arm includes a transfer segment connected to a contact arm via a contact elbow; and
wherein the transfer segment angles toward and/or is parallel with the median plane and away from the frontal plane as the retraction arm extends away from the bias device.

4. The retraction spring of claim 3, wherein the contact arm is at a generally obtuse or straight angle relative to the transfer segment so that the contact arm angles toward the median plane, the frontal plane, or both the median plane and the frontal plane.

5. The retraction spring of claim 3, wherein the transfer segment is integrally connected to the pad side arm; and
wherein the transfer segment is at a generally acute angle relative to the pad side arm.

6. The retraction spring of claim 5, wherein the anchor arm is at a generally acute angle relative to the frontal plane as the anchor arm extends away from the bias device.

7. (canceled)

8. The retraction spring of claim 5, wherein the anchor arm includes a bias lock having an upper segment and a lower segment; and
wherein the bias lock provides a holding force and an opposing holding force which fixes the anchor arm to the brake component.

9. The retraction spring of claim 8, wherein the bias lock includes one or more arcuate portions which elastically deform to provide the holding force and the opposing holding force; and
wherein the upper segment is opposing the lower segment.

10. The retraction spring of claim 1, wherein the one or more helical loops form a single coil having a plurality of helical loops.

11. The retraction spring of claim 1, wherein the brake component is a pad clip.

12. The retraction spring of claim 11, wherein the anchor arm resides within a support channel of the pad clip so that the retraction spring is attached to the pad clip.

13. The retraction spring of claim 12, wherein the one or more helical loops are entirely free of contact from the pad clip.

14. The retraction spring of claim 11, wherein a brake system comprises four or more of the retraction springs and four or more of the pad clips; and
wherein the brake system includes one or more support brackets and two or more opposing brake pads having the rotor therebetween.

15. A retraction spring assembly comprising:
a) a pad clip having a support channel adjacent to a pad channel; and
b) a retraction spring affixed to the pad clip, the retraction spring comprising:
(i) a bias device which stores energy during a brake apply and releases the energy during a brake release, the bias device having one or more helical loops with a loop axis extending therethrough and concentric with a diameter of the one or more helical loops, and the one or more helical loops are entirely free of contact from the pad clip;
(ii) an anchor arm integrally attached to the bias device, wherein the anchor arm affixes the retraction spring to the pad clip by residing within the support channel, and wherein the anchor arm includes a bias lock which is curved having an upper segment opposing a lower segment;
(iii) a retraction arm integrally attached to the bias device;
wherein the loop axis lies within and is generally parallel to a transverse plane, and a median plane is generally perpendicular to the transverse plane and also intersects the loop axis;
wherein the anchor arm and the retraction arm are located on a same side of the transverse plane;
wherein the anchor arm intersects the median plane so that the anchor arm is located on both sides of the median plane;
wherein during the brake apply, movement of the retraction arm is away from the bias device, away from the anchor arm, and/or toward a rotor and results in the energy being stored in the bias device; and
wherein during the brake release, the energy stored in the bias device is released and transferred to the retraction arm to result in movement of the retraction arm toward the bias device, toward the anchor arm, and/or away from the rotor.

16. The retraction spring assembly of claim 15, wherein the retraction arm includes a transfer segment connected to a contact arm via a contact elbow;
wherein the transfer segment angles toward the median plane as the retraction arm extends away from the bias device;
wherein a frontal plane is perpendicular to both the transverse plane and the median plane; and
wherein the contact arm is at a generally obtuse angle relative to the transfer segment so that the contact arm angles toward the median plane, the frontal plane, or both the median plane and the frontal plane.

17. The retraction spring assembly of claim 16, wherein the bias device includes a pad side arm at one end of the one or more helical loops; and
wherein the transfer segment is integrally connected with the pad side arm via a transfer elbow and extends away from the transfer elbow at a generally acute angle relative to the pad side arm.

18. The retraction spring assembly of claim 15, wherein the bias device includes a support side arm at one end of the one or more helical loops;
wherein the anchor arm includes a bias lock includes an arcuate portion connecting the lower segment with the upper segment;
wherein the bias lock elastically deforms to provide a holding force and an opposing holding force on the pad channel which fixes the anchor arm to the pad clip.

19. A brake system comprising:
a) a support bracket including a plurality of abutments;
b) a pair of brake pads opposing one another and mounted to the support bracket, each brake pad including two or more ears;
c) a rotor between the pair of brake pads;
d) a plurality of retraction spring assemblies, each comprising:
(i) a pad clip free of a bridge extending over a rotor having:
1) a support channel which receives one of the plurality of abutments of the support bracket; and
2) a pad channel which receives one of the two or more ears from one of the pair of brake pads;
(ii) a retraction spring affixed to the pad clip, the retraction spring having:
1) a bias device having one or more helical loops with a loop axis extending therethrough and concentric with a diameter of the one or more helical loops and the one or more helical loops are free of contact from the pad clip;
2) an anchor arm integrally attached to the bias device, wherein the anchor arm resides in the support channel adjacent to the abutment located within the support channel;
3) a retraction arm integrally attached to the bias device, wherein the retraction arm extends away from the bias device and is in direct contact with the ear located within the pad channel;
wherein the loop axis lies within and is generally parallel to a transverse plane and the anchor arm and the retraction arm are located on a same side of the transverse plane;
wherein a median plane is generally perpendicular to the transverse plane and also intersects the loop axis and wherein the anchor arm intersects the median plane so that the anchor arm is located on both sides of the median plane;
wherein during a brake apply, movement of the pair of brake pads toward the rotor results in each of the ears applying an inwardly force to the retraction arm which the ear is in contact with, and the retraction arm transfers the inwardly force to the bias device so that the inwardly force is stored as energy in the bias device; and
wherein during a brake release, the energy stored in the bias device is released and transferred to the retraction arm so that the retraction arm applies an outwardly force to the ear it is in direct contact with to result in movement of the pair of brake pads away from the rotor.

20. The brake system of claim 19, wherein the plurality of retraction spring assemblies includes four or more of the retraction spring assemblies.

21. The retraction spring of claim 1, wherein the pad side arm and the support side arm each extend away from the median plane while also generally parallel to the transverse plane.
